(19) United States
(12) Patent Application Publication
(10) Pub. No.: US 2015/0156209 A1
(43) Pub. Date: Jun. 4, 2015

(54) Process Using Universal Sanitization to Prevent Injection Attacks

(71) Applicant: Karen Heart, Oak Park, IL (US)

(72) Inventor: Karen Heart, Oak Park, IL (US)

(21) Appl. No.: 14/096,480

(22) Filed: Dec. 4, 2013

(51) Int. Cl. H04L 29/06

(52) U.S. Cl. CPC H04L 63/14

(57) ABSTRACT

Injection attacks, particularly SQL Injection (SQLi), remains the top risk in software, despite extensive research on methods to prevent these attacks. A novel process is set forth that would prevent injection attacks in all cases, including secondary injection, without interfering with legitimate queries. The technique is based on a simple algorithm for sanitizing input character data, rather than on a particular technology. As such, this sanitizing solution would apply to all programming languages and databases, including NoSQL databases. An alternative approach, using the sanitized version of the data in order to determine whether the original input character data contains potentially malicious data, is also set forth.

### BACKGROUND OF THE INVENTION

Injection attacks, particularly, SQL Injection (SQLi), remains the top risk in software, despite extensive research on techniques and tools to mitigate such attacks [1]. Indeed, researchers have succeeded in devising very clever and amazingly sophisticated approaches to solve this problem. All of them are reported to have achieved a high degree of success in mitigating, if not outright preventing, SQLi. Yet, all of these techniques have drawbacks that have limited their adoption. Another approach is needed.

Typically, queries are created dynamically by source code that combines a predetermined query structure with data input from a user. For example, suppose a simple web application asks for a login and a password in order to authorize a user to use the application further. The user enters the data, “BobJ” for the login and “password1234” for the password. A simple query that incorporates this information and checks it against the database might look as follows. Note that the password is inappropriately passed in clear text solely for purposes of simplifying the example:

SELECT*from users WHERE login=‘BobJ’ and password=‘password1234’;

In order to construct this query, the application code would characteristically create a static string containing the command structure of the query and concatenate the user data input. For example, the code might appear as follows:

String login=getUserLogin( );

String password=getUserPassword( );

String query=“SELECT*from users WHERE login=′”+login+“′ and password=′”+password+“′”;

(additional spaces added for clarity)

If an attacker wished to bypass the password check but was aware of Bob's login name, the attacker could enter the following string for the login:

Bobj′ OR 1=1—gonofurther

Unless the programmer properly validates the data entered, the query would be constructed as follows:

SELECT*from users WHERE login=‘BobJ’ OR 1=1—gonofurther and password=″

The query now includes an alternative test, 1=1, which always resolves to true, and the double dashes following the additional test comments out the remainder of the query. Consequently, the database server would retrieve the record for Bob, thereby allowing the attacker to login without need of a password.

All current approaches for solving this problem may be divided generally into three classes. One class of approaches is aimed at detecting queries that contain potentially malicious input and preventing them from being executed. A second class of approaches use a feature of the database server to separate the command structure from the data in the query, known as a Prepared Statement. A variation on this theme includes research that has focused on creating alternative means for achieving this separation through additional software libraries that perform the work, rather than relying solely on the database server. Finally, the traditional approach is to sanitize user input by replacing potentially malicious data with benign representations or removing it altogether. In short, the three classes of approaches include preventing potentially malicious queries from executing, better separating the command structure from the data, and altering the input. Additionally, several proposals have combined these approaches into hybrid methods.

The first class of approaches seems the least intrusive because it does not insist upon changing the query. However, it also appears to be the least reliable approach because it relies on prediction. In their classic paper on the tool AMNESIA, Halfond and Orso demonstrated a method for creating an abstract representation of queries using static analysis and comparing that abstraction to the actual structure of the same query at runtime [2]. Others have developed their own means for comparing statically-determined structure to the query structure at runtime that contains input data [3, 4, 5, 6, 7]. Although comparing runtime versions of queries can be highly successful much of the time, it is limited by the analysis of the original query structure. For example, the ultimate structure of a query that is constructed in part using a loop, such as when concatenating multiple search parameters in a WHERE clause, is unknown during static analysis. In an unusual case, researchers compared the results of a Lightweight Directory Access Protocol (LDAP)-modeled version of the runtime query to the SQL version in order to determine the latter's validity [8]. This technique is highly dependent on the use of a bridge between SQL and LDAP, and it requires a high degree of precision to assure that the translation is not only correct but also covers all cases of potential vulnerabilities.

Perhaps the most compelling design of a system that prevents malicious queries from executing was put forth by Sun and Beznosov [9]. Their system relies on intercepting all HTTP requests, as well as all queries sent to the database server. One module stores metadata that marks all request data as tainted. When a query is sent, another module inspects the query for tainted data in order to infer the design of the original query as constructed in code. By comparing the inferred structure to the actual structure, Sun and Beznosov were able to successfully delineate valid queries from malicious ones in over 70,000 trials, without a single false positive or false negative. Relying on object-oriented aspects of Java and ASP, this approach can achieve its goal provided the source code does not contain unusual string handling. Even so, the cost of retrofitting such code would likely be very low because such coding practices are considered rare. Because of its reliance on HTTP infrastructure to mark data as tainted, however, this approach does not address secondary injection attacks. It also remains to be seen whether this approach can be applied to non-object oriented systems, such as older PHP applications and systems deployed by banks that continue to use COBOL.

The second class of approaches typically use Prepared Statements, which were designed specifically to separate command language from data and work well in preventing injection to SQL data values. Research has focused on methods to automatically revise source code so that it uses Prepared Statements instead of traditional queries [10, 11, 12]. Because this type of code revision depends on static analysis, it also suffers from the same obstacle presented by queries whose structure is not known until runtime. Moreover, Prepared Statement libraries, such as the one in Java, do not support batch queries, which are commonly used by large organizations. Such support is lacking because Prepared Statements require that the structure of the query never change, including the tables and columns referenced; and batch queries may well contain a variety of query structures, even if their differences are only slight. Finally, Prepared Statements are limited to isolating SQL data values; dynamically-composed queries that include substitution in other parts of the query are not protected by Prepared Statements.

Approaches that rely on separating the command structure from the data by marking the commands rather than the data are, indeed, extraordinarily clever and address the limitations of Prepared Statements. Proposed methods of this type use some form of randomization in order to prevent attackers from guessing the transformed command structure [13, 14, 15, 16]. Yet, these methods are still dependent on correctly assessing the potential maliciousness of the input data. Moreover, reliance on an underlying static analysis of the source code in order to transform the command language poses the same problem of dynamically-created queries whose final structure remains unknown until runtime.

Approaches belonging to the third class use various forms of input sanitization. This class is the only type of approach that is guaranteed to succeed in all cases, but only if implemented properly. A review of the problem of properly sanitizing data found that sanitization could, indeed, prevent SQLi, but that programmers often apply sanitizers incorrectly [17]. Much research has focused on automating the process of revising source code in order to correctly place sanitizers where needed [12, 18, 19, 20, 21, 22], while others have implemented frameworks for adding appropriate sanitization [23, 24, 25, 26, 27]. This research has relied on existing sanitization libraries, however, and additional research has shown that such libraries are not reliable and fail to cover all cases [28].

### BRIEF SUMMARY OF THE INVENTION

The invention sets forth two precise algorithms, one for transforming input character data into hexadecimal digit notation and the other for reversing the transformation and restoring the data to its original state. In its preferred embodiment, the invention solves the problem of injection attacks by applying this transformation to input character data used in the dynamic construction of queries. Because the transformation renders the data inert, the constructed query cannot trigger any attack embedded within the input character data. Moreover, the transformation does not prevent or otherwise impede the use of any input character data and therefore poses no limitations on functionality. The reverse transformation is applied to character data received as part of the results of the query, thereby restoring the data to its original state. This transformation and reverse transformation process may be used with any programming language and any database management system.

In an alternative embodiment, the transformation algorithm is applied to a copy of the input character data, and the query is constructed using the transformed copy. The query is then analyzed in order to determine whether undesirable data, such as representing an embedded attack, is contained within the query. If so, the query is rejected, thereby preventing any potential attack. Otherwise, the query is reconstructed using the original input character data and then executed in normal fashion, thereby achieving the desired functionality.

### BRIEF DESCRIPTION OF DRAWINGS

Not applicable

### DETAILED DESCRIPTION OF THE INVENTION

If a universal sanitizer existed that always guaranteed success, the problem of placing sanitizers that always function correctly at the necessary points in source code could be solved in one fell swoop. However, a universal sanitizer would need to meet two important constraints. First, it must assure that a sanitized string contain only inert characters. For purposes of this discussion, an inert character is defined as one that cannot trigger a database server to perform a data transformation or any other action in response to encountering that character. In essence, inert characters are those that must be treated by database servers as simple text data. Second, the sanitization process cannot restrict the set of inputs because it would then limit functionality.

Given these two constraints, it is immediately apparent that, at least with regard to ASCII, there are 62 characters that are inert: all of the letters in upper and lower case, and the ten digits. Thus, a representation of input transformed into a version of base 62 that uses only these digits and letters would prove to be inert in every instance. Additionally, all possible characters could be represented in base62 without restriction. The use of base 62, however, is not simple and may well lead to the introduction of errors and potential vulnerabilities.

In order to make use of inert characters in a practical way, a more manageable subset of the set of 62 letters and digits must be chosen. A simple subset consisting of the ten digits and the first six capital letters, A through F, will achieve the same end goal. All sixteen of these characters are inert, and because this subset describes the set of characters used for expressing hexadecimal values, any character input may be encoded using this a scheme. Moreover, encoding and decoding would become trivial, as hexadecimal representation of character data is routine.

The use of hexadecimal digit representation is achieved as follows. Each character in the data is transformed into two new characters, each being one-half of the hexadecimal representation of the underlying value of the original character. Hence, this approach would apply to all Unicode characters, which, of course, includes the ASCII set, as well as the often overlooked EBCDIC. For example, suppose a string supplied by a user begins with the letter, ‘A’. Because the hexadecimal representation of the letter A in ASCII is 0x41, this letter would be transformed into two characters, a digit ‘4’ followed a digit ‘1’. By transforming all of the characters in string data in this fashion, the result would be a continuous string of characters that would include only the digits 0 to 9 and the capital letters A through F. Reversing the transformation would be trivial, such as when needed to output the data to an application.

So long as this transformation technique is applied consistently, the database application would work the same as before. For example, suppose a record is inserted into a table named “employees”, and the data for the field “last_name” is ‘Jones’. Because the letter ‘J’ has the ASCII hexadecimal value 4A, the letter ‘o’ has the value 6F, the letter ‘n’ 6E, and so forth, the five characters in “Jones” would be transformed into the 10 character string “4A6F6E6573” and stored as such by the INSERT query. When a query searches for that employee's record by last name, the data in the WHERE clause would first be transformed by the same algorithm so that it would appear to the database server as “WHERE last_name=‘4A6F6E6573’”, thereby causing the database server to look for the same 10 character sequence, and consequently finding the correct match. Upon retrieval of the desired record, the transformation would be reversed so that the last name data would appear to the application as ‘Jones’.

Because hexadecimal digit representation renders the input data completely inert, the database server would never attempt to transform the data or be triggered to take any other actions. The essence of SQLi is to provoke the database server to run a query that differs from the original one intended by the programmer, and hexadecimal digit representation eliminates such possibilities. Thus, this process would prevent SQLi in all cases, including secondary injection, while never interfering with legitimate queries.

For those less familiar with the inner workings of database servers and therefore skeptical that a string of hexadecimal characters would never trigger an action, consider what actions a database server could potentially take in such a situation. The database server's parser may well recognize the string as a hexadecimal sequence. However, if the database server then transformed the data from hexadecimal into characters, it may well be destroying data without any justification. For example, suppose the string ‘41’ is passed via a query to the database. If the database server arbitrarily converted the string to the letter ‘A’ because 41 is the hexadecimal value for that character, then the original string would be destroyed. As a rule, then, the database server must not automatically apply any transformations unless presented with additional non-hexadecimal characters, such as \x, that indicate the need or expectation for transformation. The disclosed process never produces non-hexadecimal characters; consequently, no server would ever rightfully apply an automatic conversion to the transformed data.

Moreover, this transformation can be added easily to code that constructs part of the query using a loop, an important issue mentioned above. Hence, the fact that the ultimate structure of the query would not be known until runtime would not impede proper encoding. More importantly however, this transformation could be split easily across multiple source files, which is often necessary in large applications that use a combination of front-end and library modules to gather user input, compose and execute queries, and output results. Furthermore, such transformation is not tied to any particular library or language construct, therefore it can be used with all programming languages and databases, including NoSQL databases. Finally, as amply demonstrated by prior research, a tool can be created that parses source code and automatically revises it to include encoding statements for all string data input, as well as reverse transformations for records found.

A small encoding library function was created using Java in order to demonstrate that the invention, in its preferred embodiment, would, indeed, transform all inputs, including malicious ones, into harmless sequences of inert characters. Examples of malicious inputs were drawn from research cited above, as well as the introductory example.

TABLE 1
Transformations of Malicious Inputs

| | |
|---|---|
| Input: | Bobj' OR 1 = 1 − gonofurther (example above) |
| Transformed: | 426F626A27204F522031203D2031202D2D20676F6E6F6675727 |
| | 4686572 |
| Input: | ′ UNION SELECT * FROM table WHERE condition ′ [5] |
| Transformed | 201920554E494F4E2053454C454354202A2046524F4D2074616 |
| | 26C6520574845524520636F6E646974696F6E202019 |
| Input: | ; DROP TABLE tablename; - - [5] |
| Transformed | 3B2044524F50205441424C45207461626C656E616D653B202D2 |
| | D20 |
| Input: | ′/**/OR/**/'a'/**/=/**/′ [5] |
| Transformed | 20192F2A2A2F4F522F2A2A2F20196120192F2A2A2F3D2F2A2A2 |
| | F2019 |
| Input: | ; exec(char(0x73687574646f776e)) - - [29] |
| Transformed | 3B2065786563286368617228307837333638373537343634366 |
| | 6373736652929202D2D |

Table 1 above contains the inputs tested, all of which are representative of SQLi attacks often encountered. Additionally, the table contains references to their sources and the results of transformation using the hexadecimal digit algorithm. As readily observed, none of the unusual characters in the malicious output, such as punctuation marks or spaces, interfered with the process of transformation. All of these inputs were easily converted into a sequence of inert characters, thereby preventing any type of attack. Moreover, no characters were omitted during transformation because they may all be used in legitimate queries.

There are two known limitations to this approach, however. This type of encoding doubles the size of string data. Therefore, databases would have to be enlarged to handle the extra data. Storage costs are relatively cheap, though. The second limitation is that more data would be sent over the network between the web or application server and the database server for each query. Paradoxically though, a small increase in the size of the query may simply slow the rate at which database servers must handle transactions and cause an increase in performance, analogous to increases in performance of TCP transmissions when flow control is optimized. Assuming, arguendo, that the additional traffic substantially degrades the performance of a large-scale system that processes a great volume of transactions, all hope is not lost. A quick check using default gzip compression (on Linux Mint 14) revealed that a sequence of 8296 hexadecimal digits, representing 4148 original characters, compressed rapidly to only 2143 bytes. Thus, compression and decompression modules could be interposed between the web server and the database server in order to obviate the increase in traffic. On any account, the added costs imposed by increased storage and network traffic, even when considered together, are likely more than offset by the gains achieved by preventing all SQLi attacks.

Nonetheless, in cases where doubling the capacity of the database and using compression is considered infeasible, an alternative embodiment, involving a hybrid approach, could be utilized. Hexadecimal digit encoded data could be substituted for taint-marked data in the approach proposed by Sun and Besnosov. Then, if a comparison of the intended query structure matches the actual query, the query would be sent using the original data. This embodiment would have the added benefits of being able to work with existing databases and not increasing either the size of the database or network traffic. However, this alternative embodiment would work only as well as the code that compares the query structures. If the comparison code contains any errors of logic, then the embodiment may produce false positives that prevent legitimate queries and, worse, false negatives that permit malicious ones. Coding errors notwithstanding, it remains to be seen whether comparing query structures dynamically can eliminate all potential SQLi attacks with complete accuracy. Thus, the simple sanitizer preferred embodiment and the hybrid version pose a trade-off between the size of data and accuracy in comparative analysis.

### REFERENCES

[1] Top 10 2013-Top 10. OWASP, accessed Nov. 26, 2013, https://www.owasp.org/index.php/Top_{—}10_{—}2013-Top_{—}10

[2] Halfond, W. G. J, and Orso, A. Preventing SQL injection attacks using AMNESIA. In Proc., ICSE '06, ACM (2006), 795-798.

[3] Kar, D. and Panigrahi, S. Prevention of SQL Injection attack using query transformation and hashing. IEEE 3rd International Advanced Computing Conference, IEEE (2013), 1317-1323.

[4] Bisht, P.; Madhusudan, P.; and Venkatakrishnan, V. N. CANDID: Dynamic candidate evaluations for automatic prevention of SQL injection attacks. ACM Trans. Inf. Syst. Secur. 13, 2, Article 14 (March 2010), 1-39.

[5] Bao, T.; Matsumoto, S.; and Nir, J. D. Preventing SQL Injection with Input Rectification. (2013). Retrieved Nov. 22, 2013, from http://18739c.ece.cmu.edu/bravo-2/wp-content/uploads/sites/9/2013/03/report.pdf.

[6] Wassermann, G. and Su, Z. Sound and precise analysis of web applications for injection vulnerabilities. In Proceedings of the 2007 ACM SIGPLAN Conference on Programming Language Design and Implementation, ACM (2007), 32-41.

[7] Son, S.; McKinley, K. S.; and Shmatikov, V. Diglossia: detecting code injection attacks with precision and efficiency. In Proceedings of the 2013 ACM SIGSAC Conference on Computer & Communications Security, ACM (2013), 1181-1192.

[8] Zhang, K.; Lin, C.; Chen, S.; Hwang, Y.; Huang, H.; and Hsu, F. TransSQL: A Translation and Validation-Based Solution for SQL-injection Attacks. In Proc., 2011 First International Conference on Robot, Vision and Signal Processing (2011), 248-251.

[9] Sun, S. and Beznosov, K. Retrofitting Existing Web Applications with Effective Dynamic Protection Against SQL Injection Attacks. IJSSE 1, 1 (2010), 20-40.

[10] Bisht, P.; Sistla, A. P.; and Venkatakrishnan, V. N. Automatically preparing safe SQL queries. In Proceedings of the 14th international conference on Financial Cryptography and Data Security, Springer-Verlag (2010), 272-288.

[11] Thomas, S.; Williams, L.; and Xie, T. 2009. On automated prepared statement generation to remove SQL injection vulnerabilities. Inf. Softw. Technol. 51, 3 (March 2009), 589-598.

[12] Abadi, A.; Ettinger, R.; Feldman, Y. A.; and Shomrat, M. Automatically fixing security vulnerabilities in Java code. In Proceedings of the ACM International Conference Companion on Object Oriented Programming Systems Languages and Applications Companion, ACM (2011), 3-4.

[13] Johns, M. and Beyerlein, C. SMask: preventing injection attacks in web applications by approximating automatic data/code separation. In Proceedings of the 2007 ACM symposium on Applied computing, ACM (2007), 284-291.

[14] Halder, R. and Cortesi, A., Obfuscation-based analysis of SQL injection attacks. In Proc., 2010 IEEE Symposium on Computers and Communications, IEEE (2010), 931,938.

[15] Mittal, P. and Jena, S. K. A fast and secure way to prevent SQL injection attacks. In 2013 IEEE Conference on Information & Communication Technologies, IEEE (2013), 730-734.

[16] Boyd, S. W. and Keromytis, A. D. SQLrand: Preventing SQL Injection Attacks. In Proceedings of the 2nd Applied Cryptography and Network Security (2004), 292-302.

[17] Scholte, T.; Robertson, W.; Balzarotti, D.; and Kirda, E. 2012. An empirical analysis of input validation mechanisms in web applications and languages. In Proceedings of the 27th Annual ACM Symposium on Applied Computing, ACM (2012), 1419-1426.

[18] Livshits, B. and Chong, S. Towards fully automatic placement of security sanitizers and declassifiers. SIGPLAN Not. 48, 1 (January 2013), 385-398.

[19] Saxena, P.; Molnar, D.; and Livshits, B. SCRIPTGARD: automatic context-sensitive sanitization for large-scale legacy web applications. In Proceedings of the 18th ACM Conference on Computer and Communications Security, ACM (2011), 601-614.

[20] Huang, Y.; Yu, F.; Hang, C.; Tsai, C.; Lee, D.; and Kuo, S. Securing web application code by static analysis and runtime protection. In Proceedings of the 13th International Conference on World Wide Web, ACM (2004), 40-52.

[21] Yu, F.; Alkhalaf, M.; and Bultan, T. Patching vulnerabilities with sanitization synthesis. In Proceedings of the 33rd International Conference on Software Engineering, ACM (2011), 251-260.

[22] Mui, R. and Frankl, P. Preventing SQL Injection through Automatic Query Sanitization with ASSIST. Fourth International Workshop on Testing, Analysis and Verification of Web Software 35 (2010), 27-38.

[23] Rafailidis, F.; Panagos, I.; Katsaros, P.; and Arvanitidis, A. Inlined monitors for security policy enforcement in web applications. In Proceedings of the 17th Panhellenic Conference on Informatics, ACM (2013), 75-82.

[24] Yip, A.; Wang, X.; Zeldovich, N.; and Kaashoek, M. F. 2009. Improving application security with data flow assertions. In Proceedings of the ACM SIGOPS 22nd Symposium on Operating Systems Principles, ACM (2009), 291-304.

[25] Samuel, M.; Saxena, P.; and Song D. Context-sensitive auto-sanitization in web templating languages using type qualifiers. In Proceedings of the 18th ACM Conference on Computer and Communications Security, ACM (2011), 587-600.

[26] Reischuk, R. M.; Backes, M.; and Gehrke, J. 2012. SAFE extensibility of data-driven web applications. In Proceedings of the 21st International Conference on World Wide Web, ACM (2012), 799-808.

[27] Hermosillo, G.; Gomez-Cardenas, R.; Seinturier, L.; and Duchien, L. AProSec: An aspect for programming secure web applications. The Second International Conference on Availability, Reliability and Security, IEEE (2007), 1026-1033.

[28] Balzarotti, D.; Cova, M.; Felmetsger, V.; Jovanovic, N.; Kirda, E.; Kruegel, C.; and Vigna, G. Saner: Composing Static and Dynamic Analysis to Validate Sanitization in Web Applications. In Proc., IEEE Symposium on Security and Privacy, IEEE (2008), 387-401.

[29] Halfond, W. G. J.; Viegas, J.; and Orso, A. A Classification of SQL Injection Attacks and Countermeasures. (2006). Retrieved Nov. 20, 2013 from http://www.cc.gatech.edu/˜orso/papers/halfond.viegas.orso.ISSSE06.pdf

1. A method performed by at least one computer processor for transforming character data that is input to the computer system, comprising the steps of:
a) receiving, by the computer processor, untrusted character data from a user, file, or other sources; and
b) encoding, by the computer processor, said untrusted character data into data consisting of the hexadecimal digit representation that corresponds to the underlying numeric values used by said computer processor to store and process said untrusted character data; or
c) receiving, by the first computer processor, character data sent from a second computer system to the first, where said data is encoded by the means described above in b); and
d) decoding, by the first computer processor, of the received character data from hexadecimal digit representation into corresponding numeric values used by said first computer processor for storing and processing character data.

2. The method as claimed in claim 1, wherein each byte of untrusted character data is encoded into two bytes of character data representing hexadecimal digit values.

3. The method as claimed in claim 1, wherein the encoded data is used thereafter by said computer processor instead of the untrusted data in constructing database transaction requests.

4. (canceled)

5. The method as claimed in claim 1, wherein each pair of received character data is decoded from hexadecimal digit representation into a single byte representing the underlying numeric value that corresponds to said hexadecimal digit representation.

6. The method as claimed in claim 1, wherein the decoded data is used thereafter by the first computer processor instead of the retrieved data for further processing.

7. A method performed by at least one computer processor for preventing injection attacks against second computer processors conducting database transactions, comprising the steps of:
a) encoding, by the first computer processor, untrusted character data into hexadecimal digit representation;
b) using said encoded data instead of the untrusted data for constructing database transaction requests;
c) transmitting said transaction requests to said second computer processors;
d) receiving character data from said second computer processors in response to said database transaction requests;
e) decoding character data contained in said response from hexadecimal digit representation into numeric values corresponding to said hexadecimal digit representation; and
f) providing said decoded character data for use by said first computer processor for further processing.

8. The method as claimed in claim 7, wherein each byte of untrusted character data is encoded into two bytes of character data representing hexadecimal digit values.

9. The method as claimed in claim 7, wherein each pair of received character data is decoded from hexadecimal digit representation into a single byte representing the underlying numeric value that corresponds to said hexadecimal digit representation.

10. A method performed by at least one computer processor for preventing injection attacks against second computer processors conducting database transactions, comprising the steps of:
a) encoding, by the first computer processor, a copy of untrusted character data into hexadecimal digit representation;
b) using said encoded data instead of the untrusted data for constructing database transaction requests, also known as queries;
c) analyzing said database transaction requests, also known as queries, to determine whether the original untrusted character data contained undesirable data, such as may be used for an injection attack;
d) rejecting the query in cases where said analysis determines that such undesirable data is present; and
e) in cases where said analysis does not indicate the presence of undesirable data, reconstructing the query using the original untrusted data and then executing the query.

11. The method as claimed in claim 10, wherein each byte of untrusted character data is encoded into two bytes of character data representing hexadecimal digit values.
